(19) United States
(12) Patent Application Publication
(10) Pub. No.: US 2022/0201786 A1
(43) Pub. Date: Jun. 23, 2022

(54) METHODS AND APPARATUS TO REDUCE PACKET LATENCY IN MULTI-LEG TRANSMISSION

(71) Applicant: MEDIATEK INC., Hsin-Chu (TW)

(72) Inventors: Chun-Fan Tsai, Hsin-Chu (TW); Pradeep Jose, Cambridge (GB); Chi-Hsuan Hsieh, Hsin-Chu (TW); Cheng-Hsun Li, Hsin-Chu (TW); Wei-De Wu, Hsin-Chu (TW)

(21) Appl. No.: 17/542,407

(22) Filed: Dec. 4, 2021

Related U.S. Application Data
(60) Provisional application No. 63/127,202, filed on Dec. 18, 2020.

(51) Int. Cl. H04W 76/16; H04W 76/20; H04L 1/16

(52) U.S. Cl. CPC H04W 76/16; H04L 1/1642; H04W 76/20

(57) ABSTRACT

A method of providing UE-initiated PDCP status report to reduce packet latency under Multi-RAT Dual Connectivity (MR-DC) is proposed. UE initializes PDCP status report based on some predefined condition configured by the network. The PDCP status report indicates which PDCP SDU is still not received by the UE via one radio link control (RLC) entity, and the network can retransmit the missing PDCP SDU via another RLC entity quickly. The network can enable/disable the PDCP status report via PDCP control PDU or via radio resource control (RRC) signaling. The PDCP status can be used for re-transmission of PDCP SDU on another RLC entity. The PDCP status can also be used as an indication of issues on one RLC entity, resulting in duplication being activated thereafter. The PDCP status report should be sent to the RLC entity that does not suffer from the PDCP packet loss.

### CROSS REFERENCE TO RELATED APPLICATIONS

This application claims priority under 35 U.S.C. §119 from U.S. Provisional Application Number 63/127,202 entitled “Methods and Apparatus to Reduce Packet Latency in Multi-leg Transmission” filed on Dec. 18, 2020, the subject matter of which is incorporated herein by reference.

### TECHNICAL FIELD

The disclosed embodiments relate generally to wireless communication, and, more particularly, to packet latency reduction in 5G New Radio (NR) systems under Multi-RAT Dual Connectivity (DC) architecture.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an Evolved Universal Terrestrial Radio Access Network (E-UTRAN) includes a plurality of evolved Node-Bs (eNodeBs or eNBs) communicating with a plurality of mobile stations, referred to as User Equipments (UEs). The 3^{rd} Generation Partner Project (3GPP) network normally includes a hybrid of 2G/3G/4G systems. With the optimization of the network design, many improvements have developed over the evolution of various standards. The Next. Generation Mobile Network. (NGMN) board, has decided to focus the future NGMN activities on defining the end-to-end requirements for 5G New Radio (NR) systems.

Dual Connectivity (DC) architecture is introduced in LTE Release 12 to increase the UE throughput. This architecture allows UE to utilize the radio resource for two nodes. In DC mode, UE is connected to one node (eNB/gNB) as Master Node (MN) and another one node (eNB/gNB) as Secondary Node (SN). The serving cell(s) belong to MN is referred as MCG (Master Cell Group) while the serving cell belong to SN is referred as SCG (Secondary Cell Group). Multi-RAT Dual Connectivity (MR-DC) architecture is further introduced in 5G. The UE could use radio resource provided by different RAT under MR-DC architecture.

Split bearer architecture is introduced for DC. In this architecture, one PDCP entity is connoted to two RLC entity (two legs), one RLC entity is corresponding to MN and the other is corresponding to SN. In uplink (UL), network could configure whether the PDCP should duplicate the same PDU to two RLC entities. This UL PDCP duplication could enable the transmission reliability. In downlink (DL), whether and when to duplicate the DL PDU to two RLC entities is up to network implementation. PDCP status report is used to inform network which PDCP PDU is received or not.

Due to the high data rate request from traffic type like Extended Reality (XR) and Cloud Gaming (CG), it usually request to use DC architecture (with 2 leg transmission in MCG and SCG) to increase the throughput. However, SCG FR2 may suffer for blockage from time to time. The mobility event (which cause some interruption) is also more frequent (than MCG) in small cell deployment. Therefore, it is desirable to have quick re-transmission mechanism on MCG leg while SCG leg is not able to deliver this kind of timing sensitive packet, or vice versa depending on the deployment.

Among the existing method, if network always duplicates packets to two leg, then it will consume too much radio resource. If RLC UM is used (which is typically for XR traffic), then the network does not know which PDU is lost. If RLC AM is used, then the network may detect the SCG blockage by RLC status report. The network can then use RRC reconfiguration (via parameter recoverPDCP) to request PDCP status report and transmit the PDCP SDU to anther RLC. This re-transmission mechanism involves a RRC reconfiguration (typical 10 ms) and could not fulfill the stringent delay requirement.

A solution is sought.

### SUMMARY

A method of providing UE-initiated PDCP status report to reduce packet latency under Multi-RAT Dual Connectivity (MR-DC) is proposed. UE initializes PDCP status report based on some predefined condition configured by the network. The PDCP status report indicates which PDCP SDU is still not received by the UE via one radio link control (RLC) entity, and the network can retransmit the missing PDCP SDU via another RLC entity quickly. The network can enable/disable the PDCP status report via PDCP control PDU or via radio resource control (RRC) signaling. The PDCP status can be used for re-transmission of PDCP SDU on another RLC entity. The PDCP status can also be used as an indication of issues on one RLC entity, resulting in duplication being activated thereafter. The PDCP status report should be sent to the RLC entity that does not suffer from the PDCP packet loss.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a 5G new radio (NR) mobile communication network under Multi-RAT Dual Connectivity (MR-DC) architecture in accordance with embodiments of the current invention.

FIG. 2 illustrates simplified block diagram of a user equipment in accordance with embodiments of the current invention.

FIG. 3 illustrates the concept of providing UE initiated PDCP status report to reduce latency in Multi-RAT Dual Connectivity (MR-DC) architecture.

FIG. 4 illustrates a sequence flow between a base station and a user equipment that supports a first embodiment of UE initiated PDCP status report in accordance with embodiments of the present invention.

FIG. 5 illustrates a sequence flow between a base station and a user equipment that supports a second embodiment of UE initiated PDCP status report in accordance with embodiments of the present invention.

FIG. 6 is a flow chart of a method of providing UE initiated PDCP status report from UE perspective in accordance with one novel aspect.

FIG. 7 is a flow chart of a method of obtaining UE initiated PDCP status report from network perspective in accordance with one novel aspect.

### DETAILED DESCRIPTION

Reference will now be made in detail to some embodiments of the invention, examples of which are illustrated in the accompanying drawings.

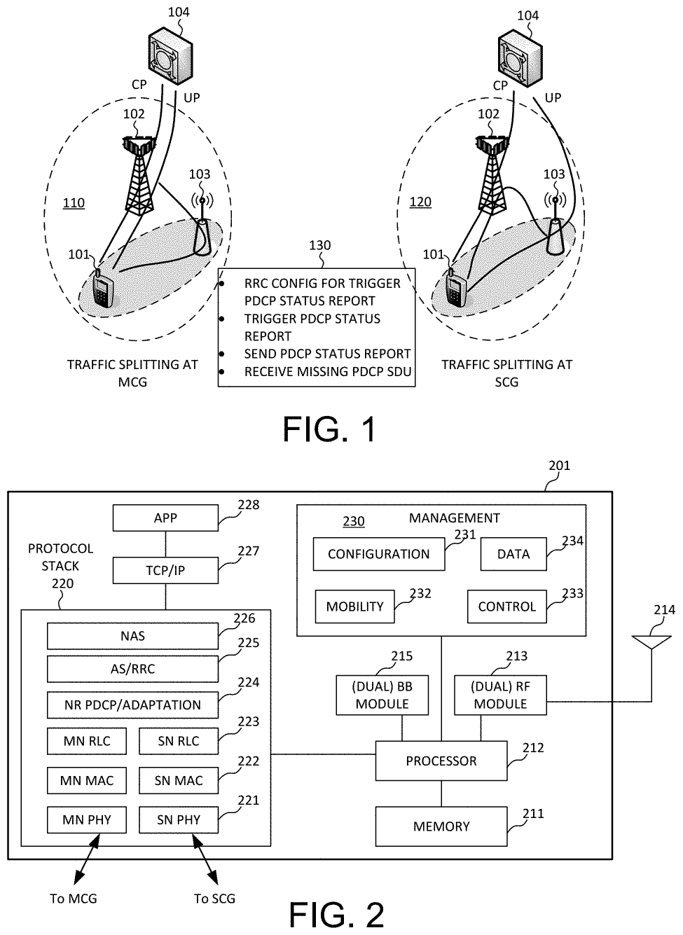

FIG. 1 illustrates a system diagram of a 5G new radio (NR) mobile communication network under Multi-RAT Dual Connectivity (MR-DC) architecture in accordance with embodiments of the current invention. 5G NR network 100 comprises a user equipment UE 101, a first base station gNB 102, a second base station gNB 103, and a core network CN 104. Dual Connectivity (DC) architecture allows UE 101 to utilize the radio resource for two nodes. In DC mode, UE 101 is connected to one node (gNB 102) as Master Node (MN) and another one node (gNB 103) as Secondary Node (SN). The serving cell(s) belong to MN is referred as MCG (Master Cell Group) while the serving cell belong to SN is referred as SCG (Secondary Cell Group). Multi-RAT Dual Connectivity (MR-DC) architecture is further introduced in 5G. The UE could use radio resource provided by different radio access technology (RAT) under MR-DC architecture. In one example, the MCG leg transmission is over FR1 and the SCG leg transmission is over FR2. In another example of EN-DC, the MCG leg transmission is over 4G LTE and the SCG leg transmission is over 5G NR.

In control plane, control signaling is communicated over MCG. In user plane, user data can be communicated over MCG and/or SCG. In split radio bearer architecture, one packet data convergence protocol (PDCP) entity is connected to two radio link control (RLC) entity (two legs), one RLC entity is corresponding to the MN and the other RLC entity is corresponding to the SN. In uplink (UL), the network could configure whether the PDCP should duplicate the same PDU to two RLC entities. This UL PDCP duplication could enable the transmission reliability. In downlink (DL), whether and when to duplicate the DL PDU to two RLC entities is up to the network implementation. PDCP status report can be used to inform the network which PDCP PDU is received or not. In the example of FIG. 1, as depicted by 110, the PDCP entity of gNB 102 (the MN) performs traffic splitting, floor control, and new PDCP header handling for IP packets received from the serving gateway. In the downlink, gNB 102 can schedule a few PDCP PDUs over MCG and the remaining over SCG. The PDCP entity of the UE 101 buffers the PDCP PDUs received over MCG and SCG and performs appropriate functions such as traffic converging and reordering, PDCP header handling, and PDCP operation. Similar functionality is also required for the uplink. The traffic splitting may also occur at the SCG, as depicted by 120 of FIG. 1.

One of the new application in 5G is to support Extended Reality (XR) and Cloud Gaming (CG) usage. The traffic characteristics of XR services include high data rate (e.g., 25 Mbps), and stringent packet delay requirement (e.g., 10 ms), while the typical enhanced mobile broadband (eMBB) packet delay budget is 800 ms. In addition, some XR/CG applications require to be supported in mobility scenario, e.g., Augmented Reality (AR) for driver, and Cloud Gaming (CG) on subway. Due to the high data rate request from traffic type like XR and CG, it usually requests to use DC architecture (with both legs transmission in MCG and SCG) to increase the throughput. However, SCG FR2 may suffer for blockage from time to time. The mobility event (which cause some interruption) in SCG is also more frequent (than in MCG) under small cell deployment. Therefore, it is desirable to have a quick re-transmission mechanism on MCG leg while SCG leg is not able to deliver this kind of timing sensitive packet, or vice versa depending on the deployment.

Among the existing method, if network always duplicates packets to two legs, then it will consume too much radio resource. If RLC Unacknowledged Mode (UM) is used (which is typically for XR traffic), then the network does not know which PDU is lost. If RLC Acknowledged Mode (AM) is used, then the network may detect the SCG blockage by RLC status report. The network can then use RRC reconfiguration (via parameter recoverPDCP) to request PDCP status report and transmit the PDCP SDU to anther RLC. This re-transmission mechanism involves a RRC reconfiguration (typical 10 ms) and could not fulfill the stringent delay requirement.

In accordance with one novel aspect, a method of providing UE-initiated PDCP status report is proposed to reduce packet latency under MR-DC (depicted by 130). UE 101 initializes PDCP status report based on predefined conditions configured by the network. The PDCP status report indicates which PDCP SDU is still not received by the UE via one RLC entity, and the network can retransmit the missing PDCP SDU via another RLC entity quickly. The network can enable or disable the PDCP status report via PDCP control PDU or via RRC signaling. The PDCP status can be used for re-transmission of PDCP SDU on another RLC entity. The PDCP status can also be used as an indication of issues on one RLC entity, resulting in duplication on both RLC legs being activated thereafter (for some or all PDCP packets). Note that the UE-initiated PDCP status report should be sent to the RLC entity that does not suffer from PDCP packet loss.

FIG. 2 illustrates a simplified block diagram for UE 201 that carry certain embodiments of the present invention. UE 201 has an antenna (or antenna array) 214, which transmits and receives radio signals. A RF transceiver module (or dual RF modules) 213, coupled with the antenna, receives RF signals from antenna 214, converts them to baseband signals and sends them to processor 212 via baseband module (or dual BB modules) 215. RF transceiver 213 also converts received baseband signals from processor 212 via baseband module 215, converts them to RF signals, and sends out to antenna 214. Processor 212 processes the received baseband signals and invokes different functional modules to perform features in UE 201. Memory 211 stores program instructions and data to control the operations of UE 201.

UE 201 also includes a 3GPP protocol stack module/circuit 220 supporting various protocol layers including NAS 226, AS/RRC 225, PDCP 224, RLC 223, MAC 222 and PHY 221, a TCP/IP protocol stack module 227, an application module APP 228, and a management module 230 including a configuration module 231, a mobility module 232, a control module 233, and a data handling module 234. The function modules and circuits, when executed by processor 212 (via program instructions and data contained in memory 211), interwork with each other to allow UE 201 to perform certain embodiments of the present invention accordingly. In one example, each module or circuit comprises a processor together with corresponding program codes. Configuration circuit 231 obtains RRC configuration information and establishes connection under dual connectivity, mobility circuit 232 determines UE mobility based on measurement results, control circuit 233 determines and applies PDCP status report, and data handling circuit 234 performs data transmission under radio bearer splitting.

UE 201 has a PHY layer, a MAC layer, and a RLC layer that connect with a master node (MN). UE 201 also has a PHY layer, a MAC layer, and a RLC layer that connect with a secondary node (SN). A NR PDCP adaptation layer handles the split radio bearer from the MN and the SN. UE 201 also has a PDCP layer entity. UE 201 aggregates its data traffic with the MN and the SN. Both the MCG data traffic and the SCG data traffic are aggregated at the PDCP layer of UE 201. For high speed data traffic, RLC layer pre-concatenation is enabled to reduce protocol related processing delay. For low speed and/or small packet size traffic, PDCP layer concatenation is enabled to reduce protocol overhead. In one novel aspect, UE 201 enables PDCP status report upon satisfying a predefined condition. As a result, the network can quickly retransmit the missing PDCP SDU to reduce packet delay.

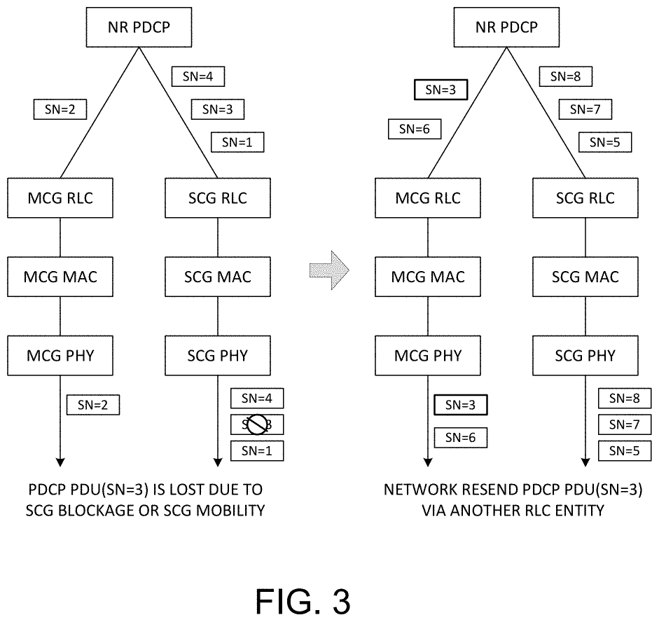

FIG. 3 illustrates the concept of providing UE initiated PDCP status report to reduce latency in Multi-RAT Dual Connectivity (MR-DC) architecture. Under DC, the NR PDCP layer handles the split radio bearer and traffic aggregation from the MCG and the SCG. The PDCP service data units (SDUs) in NR PDCP layer are forwarded to MCG RCL entity and to SCG RLC entity. In the example of FIG. 3, PDCP SDU with serial number SN=1, 3, 4 are forwarded to SCG RLC entity, while PDCP SDU with SN=2 is forwarded to MCG RLC entity. For the SCG data path, the packets are then processed by SCG MAC entity and SCG PHY entity. For the MCG data path, the packets are then processed by MCG MAC entity and MCG PHY entity. Under some scenarios, e.g., due to blockage from time to time in FR2, certain PDCP data packets may be lost. For example, the PDCP SDU with SN=3 may be lost.

UE can initialize early PDCP status report based on some predefined condition configured by the network. Under UE-initialized PDCP status report, once the predefined condition is satisfied, UE transmits an early PDCP status report to the network, which indicates which PDCP SDU is still not received by the UE via one RLC entity, and the network can retransmit the missing PDCP SDU via another RLC entity quickly to reduce packet delay. In the example of FIG. 3, upon receiving the early PDCP status report, the network knows that PDCP SDU with SN=3 is lost in the SCG RLC data path. As a result, the network resend PDCP SDU with SN=3 via the MCG RLC entity. Meanwhile, PDCP SDU with serial number SN=5, 7, 8 are forwarded to SCG RLC entity, and PDCP SDU with SN=6 is forwarded to MCG RLC entity. Note that the PDCP status report itself should be sent to the RLC entity, e.g., the MCG RLC entity, that does not suffer from PDCP packet loss.

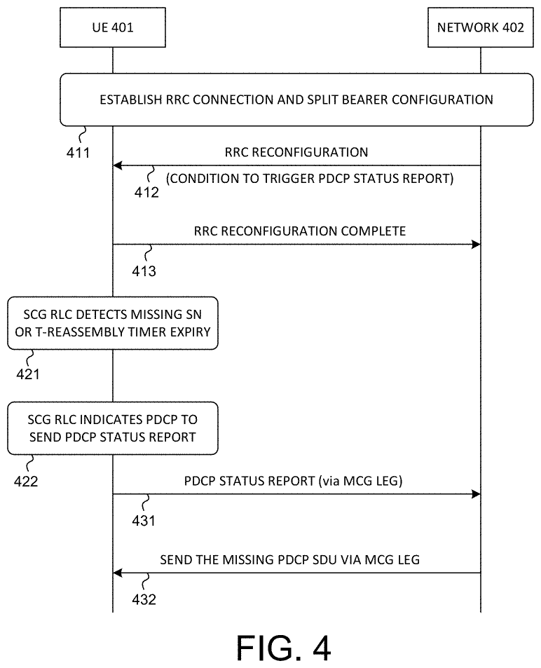

FIG. 4 illustrates a sequence flow between a base station and a user equipment that supports a first embodiment of UE initiated PDCP status report in accordance with embodiments of the present invention. Dual Connectivity is a mode of operation where a multiple Rx/Tx capable UE in RRC CONNECTED mode can be configured to utilize the radio resource of two distinct schedulers, located in two base stations, namely a Master gNB and a Secondary gNB connected via a back-haul over the X2 interface. In step 411, UE 401 establishes signaling radio bearers (SRBs), data radio bearers (DRBs), and an RRC connection with network 402, and enters RRC connected mode. UE 401 is configured with split radio bearer configuration under dual connectivity (DC), and is scheduled by both a Master node (MN) in MCG cells and a Secondary node (SN) in SCG cells.

In step 412, UE 401 receives RRC reconfiguration from the network. The RRC reconfiguration comprises information for predefined condition(s) to trigger PDCP status report. In the first embodiment of FIG. 4, the predefined conditions may include: 1) the expiry of a timer (e.g., the t-reassembly timer) associated to an RLC entity, 2) the RLC entity detects a hole in the RLC SNs (e.g., missing SN), which is the same as the timing to start or restart the t-reassembly timer. Note that t-reassembly timer is used to detect missing a RLC PDU. Once the timer timeout, the UE will discard the segments (if any) received for this RLC PDU. It is highly possible that this RLC PDU cannot be received by this RLC entity after the t-reassembly timer timeout. In step 413, UE 401 sends an RRC reconfiguration complete message to the network.

In step 421, the SCG RLC entity of UE 401 detects a missing SN, or the t-reassembly timer expires, which satisfy the predefined condition for triggering the PDCP status report. In step 422, the SCG RLC entity of UE 401 indicates to the PDCP layer entity to send a PDCP status report. In step 431, UE 401 sends the PDCP status report to the network. The PDCP status report indicates that there is a missing PDCP SDU on one RLC entity (the SCG leg), and retransmission of the missing PDCP SDU on another RCL entity (the MCG leg) is desired. Note that the PDCP status report is sent to the RLC entity that does not suffer from PDCP packet loss. In step 432, the network sends the missing PDCP SDU over the MCG leg. In an alternative embodiment, in step 431, the PDCP status report indicates that there is an issue on one RLC entity (the SCG leg), and as a result, in step 432, PDCP SDUs are being duplicated on both legs for all or part of the subsequent PDCP packets.

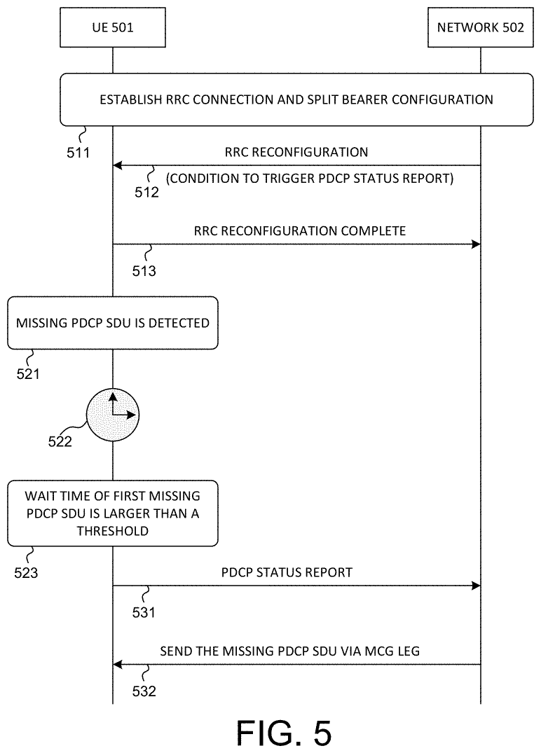

FIG. 5 illustrates a sequence flow between a base station and a user equipment that supports a second embodiment of UE initiated PDCP status report in accordance with embodiments of the present invention. In step 511, UE 501 establishes signaling radio bearers (SRBs), data radio bearers (DRBs), and an RRC connection with network 402, and enters RRC connected mode. UE 501 is configured with split radio bearer configuration under dual connectivity (DC), and is scheduled by both a Master node (MN) in MCG cells and a Secondary node (SN) in SCG cells. In step 512, UE 501 receives RRC reconfiguration from the network. The RRC reconfiguration comprises information for predefined condition(s) to trigger PDCP status report. In the second embodiment of FIG. 5, the predefined conditions may include the waiting time of a first missing PDCP SDU is larger than a threshold value. For example, the threshold value (e.g., 3 ms) is configured by the network, and UE 501 can start a timer if missing PDCP SDU is detected. In step 513, UE 501 sends an RRC reconfiguration complete message to the network.

In step 521, the SCG RLC entity of UE 501 detects a missing PDCP SDU. The missing PDCP SDU can be detected in different ways. In one example, the receiving PDCP entity could identify that there is a first missing PDCP SDU via out of order SN receiving. In a second example, the network could assume that there is DL data for a period of time, and the network may ask UE to consider there is aa missing PDCP SDU even if no out of order packet is received. In step 522, UE 501 starts a timer upon such detection, and waits for a time period that is longer than a predefined threshold value (e.g., 3 ms) to pass by. In step 523, UE 501 determines the predefined condition for triggering the PDCP status report is satisfied, and the SCG RLC entity of UE 501 indicates to the PDCP layer entity to send a PDCP status report.

In step 531, UE 501 sends the PDCP status report to the network. The PDCP status report indicates that there is a missing PDCP SDU on one RLC entity (the SCG leg), and retransmission of the missing PDCP SDU on another RCL entity (the MCG leg) is desired. Note that the PDCP status report is sent to the RLC entity that does not suffer from PDCP packet loss. In step 532, the network sends the missing PDCP SDU over the MCG leg. In an alternative embodiment, in step 531, the PDCP status report sent by the UE indicates that there is an issue on one RLC entity (the SCG leg), and as a result, in step 532, PDCP SDUs are being duplicated on both legs for all or part of the subsequent PDCP packets.

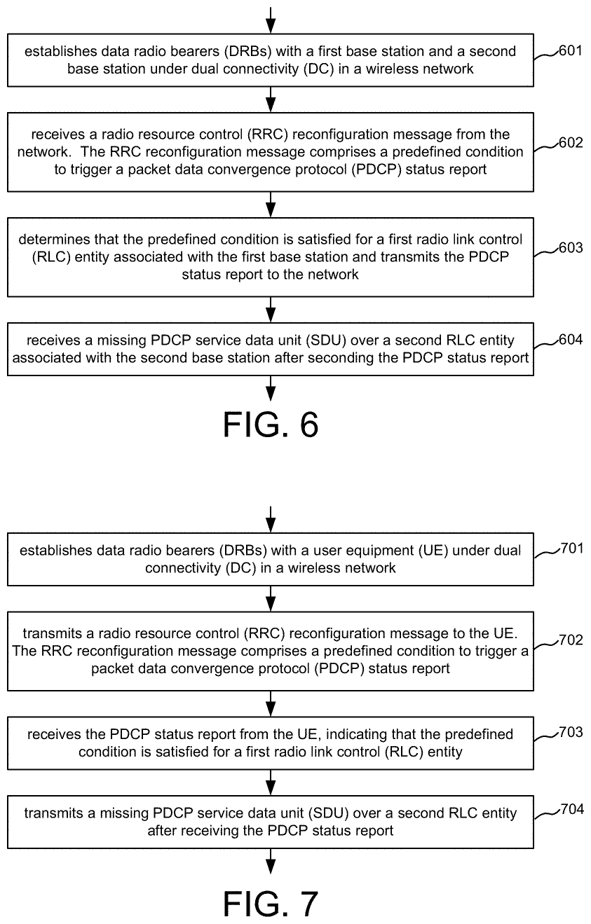

FIG. 6 is a flow chart of a method of providing UE initiated PDCP status report from UE perspective in accordance with one novel aspect. In step 601, a UE establishes data radio bearers (DRBs) with a first base station and a second base station under dual connectivity (DC) in a wireless network. In step 602, the UE receives a radio resource control (RRC) reconfiguration message from the network. The RRC reconfiguration message comprises a predefined condition to trigger a packet data convergence protocol (PDCP) status report. In step 603, the UE determines that the predefined condition is satisfied for a first radio link control (RLC) entity associated with the first base station and transmits the PDCP status report to the network. In step 604, the UE receives a missing PDCP service data unit (SDU) over a second RLC entity associated with the second base station after seconding the PDCP status report.

FIG. 7 is a flow chart of a method of obtaining UE initiated PDCP status report from network perspective in accordance with one novel aspect. In step 701, a base station establishes data radio bearers (DRBs) with a user equipment (UE) under dual connectivity (DC) in a wireless network. In step 702, the base station transmits a radio resource control (RRC) reconfiguration message to the UE. The RRC reconfiguration message comprises a predefined condition to trigger a packet data convergence protocol (PDCP) status report. In step 703, the base station receives the PDCP status report from the UE, indicating that the predefined condition is satisfied for a first radio link control (RLC) entity. In step 704, the base station transmits a missing PDCP service data unit (SDU) over a second RLC entity after receiving the PDCP status report.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
establishing data radio bearers (DRBs) by a user equipment (UE) with a first base station and a second base station under dual connectivity (DC) in a wireless network;
receiving a radio resource control (RRC) reconfiguration message from the network, wherein the RRC reconfiguration message comprises a predefined condition to trigger a packet data convergence protocol (PDCP) status report;
determining that the predefined condition is satisfied for a first radio link control (RLC) entity associated with the first base station and transmitting the PDCP status report to the network; and
receiving a missing PDCP service data unit (SDU) over a second RLC entity associated with the second base station after seconding the PDCP status report.

2. The method of claim 1, wherein the PDCP status report indicates that the missing PDCP SDU is to be retransmitted via the second RLC entity.

3. The method of claim 1, wherein the predefined condition is defined as an expiry or a start of a reassembly timer corresponding to the first RLC entity.

4. The method of claim 1, wherein the predefined condition is defined as a waiting time of a first missing PDCP SDU is longer than a threshold time.

5. The method of claim 4, wherein the first missing PDCP SDU is detected based on a received PDCP SDU sequence number (SN).

6. The method of claim 4, wherein the first missing PDCP SDU is detected based on no data being received over a DRB via the first RLC entity over a period of time.

7. The method of claim 1, wherein the PDCP status report indicates that packet duplication over the first base station and the second base station is to be activated for all or part of data traffic.

8. The method of claim 1, wherein the PDCP status report is enabled or disabled via a PDCP controlling protocol data unit (PDU) or via RRC signaling.

9. A user equipment (UE), comprising:
a control circuit that establishes data radio bearers (DRBs) with a first base station and a second base station under dual connectivity (DC) in a wireless network;
a configuration circuit that receives a radio resource control (RRC) reconfiguration message from the network, wherein the RRC reconfiguration message comprises a predefined condition to trigger a packet data convergence protocol (PDCP) status report;
a transmitter that transmits the PDCP status report to the network upon determining that the predefined condition is satisfied for a first radio link control (RLC) entity associated with the first base station; and
a receiver that receives a missing PDCP service data unit (SDU) over a second RLC entity associated with the second base station after seconding the PDCP status report.

10. The UE of claim 9, wherein the PDCP status report indicates that the missing PDCP SDU is to be retransmitted via the second RLC entity.

11. The UE of claim 9, wherein the predefined condition is defined as an expiry or a start of a reassembly timer corresponding to the first RLC entity.

12. The UE of claim 9, wherein the predefined condition is defined as a waiting time of a first missing PDCP SDU is longer than a threshold time.

13. The UE of claim 12, wherein the first missing PDCP SDU is detected based on a received PDCP SDU sequence number (SN).

14. The UE of claim 12, wherein the first missing PDCP SDU is detected based on no data being received over a DRB via the first RLC entity over a period of time.

15. The UE of claim 9, wherein the PDCP status report indicates that packet duplication over the first base station and the second base station is to be activated for all or part of data traffic.

16. The UE of claim 9, wherein the PDCP status report is enabled or disabled via a PDCP controlling protocol data unit (PDU) or via RRC signaling.

17. A method comprising:
establishing data radio bearers (DRBs) by a base station with a user equipment (UE) under dual connectivity (DC) in a wireless network;
transmitting a radio resource control (RRC) reconfiguration message to the UE, wherein the RRC reconfiguration message comprises a predefined condition to trigger a packet data convergence protocol (PDCP) status report;
receiving the PDCP status report from the UE, indicating that the predefined condition is satisfied for a first radio link control (RLC) entity; and
transmitting a missing PDCP service data unit (SDU) over a second RLC entity after receiving the PDCP status report.

18. The method of claim 17, wherein the PDCP status report indicates that the missing PDCP SDU is to be retransmitted via the second RLC entity.

19. The method of claim 17, wherein the predefined condition is defined as an expiry or a start of a reassembly timer corresponding to the first RLC entity.

20. The method of claim 17, wherein the predefined condition is defined as a waiting time of a first missing PDCP SDU is longer than a threshold time.

21. The method of claim 17, wherein the PDCP status report is enabled or disabled via a PDCP controlling protocol data unit (PDU) or via RRC signaling.
